(19) United States
(12) Patent Application Publication
(10) Pub. No.: US 2025/0379841 A1
(43) Pub. Date: Dec. 11, 2025

(54) TECHNIQUES FOR MANAGING EMAILS

(71) Applicant: Apple Inc., Cupertino, CA (US)

(72) Inventors: Lance C. TYLER, Campbell, CA (US); Ankit CHAUDHARY, Newark, CA (US); Jin Hyuk CHO, Santa Clara, CA (US); Sudarshan R. BHAT, Morgan Hill, CA (US); Anwesha CHATTERJEE, Sunnyvale, CA (US); Geoffrey G. CHEMMANNOOR, San Jose, CA (US)

(21) Appl. No.: 19/230,712

(22) Filed: Jun. 6, 2025

Related U.S. Application Data
(60) Provisional application No. 63/657,746, filed on Jun. 7, 2024.

(51) Int. Cl. H04L 51/42

(52) U.S. Cl. CPC H04L 51/42

(57) ABSTRACT

A method for managing emails is disclosed. A computer device may determine of unwanted email senders from which a user is receiving emails. The list of unwanted email senders may be ranked, and subsets of the list may be displayed on a user device to solicit input from the user regarding the email senders. Upon receiving decisions from the user regarding the email senders, the computer device may perform actions for corresponding ones of the email senders.

### CROSS-REFERENCE TO RELATED APPLICATIONS

The present application claims the benefit of U.S. Provisional Application No. 63/657,746, entitled “TECHNIQUES FOR MANAGING EMAILS,” filed Jun. 7, 2024, the content of which is incorporated by reference herein in its entirety for all purposes.

### FIELD

The described embodiments relate generally to techniques for managing emails.

### BACKGROUND

Organizing emails effectively is a significant challenge due to the sheer volume and variety of communications that people receive on a daily basis. One of the primary difficulties is managing the influx of emails, which can quickly become overwhelming. Users often subscribe to numerous newsletters, receive promotional offers, and handle multiple correspondences simultaneously. This results in a cluttered inbox, making it hard to identify and prioritize important messages. The constant barrage of incoming emails requires continuous attention, which can distract from more focused, productive work.

Another challenge is the lack of standardization in email content and formatting. Emails can vary widely in their structure, tone, and purpose, making it difficult to apply a one-size-fits-all organizational strategy. Some emails may require immediate action, while others might be informational or for later reference. Tools like folders and labels can help, but they require diligent manual sorting, which can be time-consuming and prone to human error. Moreover, as projects and priorities shift, the relevance of certain emails may change, necessitating ongoing reorganization efforts to keep the system effective.

Additionally, the search functionality offered by email clients often falls short in practice. Users may struggle to remember specific details needed to retrieve a past email, leading to wasted time and frustration. Advanced search techniques, while helpful, can be cumbersome and require a level of proficiency that not all users possess. Consequently, even well-organized inboxes can suffer from lost or hard-to-find emails, especially if the user's organizational strategy relies heavily on specific keywords or dates.

Additionally, integrating email organization with other digital tools and workflows presents another layer of complexity. Many people use emails in conjunction with calendars, task managers, and collaboration platforms. Ensuring that important emails are appropriately flagged or linked across these tools can be cumbersome and inconsistent. This fragmentation can lead to missed deadlines, overlooked tasks, and a general decrease in productivity. Effective email organization thus demands a holistic approach, considering not just the inbox itself but its interaction with the broader digital environment.

### SUMMARY

The described aspects relate generally to techniques for managing emails.

According to one aspect, a method for managing emails may include determining, by a computing device, a plurality of email senders for a user, and determining, by the computing device, a plurality of first rank values for corresponding email senders of the plurality of email senders. The method may further include determining, by the computing device, a plurality of second rank values for corresponding email senders of a subset of the plurality of email sender, and displaying, by the computing device on a user device associated with the user, the subset of the plurality of email senders in an order based on the plurality of second rank values. The method may also include receiving, by the computing device from the user, a plurality of decisions regarding corresponding email senders of the subset of the plurality of email senders, and performing, by the computing device, an action associated with a particular email sender of the subset of the plurality of email senders based on a corresponding decision of the plurality of decisions.

Other aspects can include a non-transitory computer readable storage medium configured to store instructions that, when executed by a processor included in a computing device, cause the computing device to carry out the various steps of any of the foregoing methods. Further aspects include a computing device that is configured to carry out the various steps of any of the foregoing methods.

Other aspects and advantages of the embodiments described herein will become apparent from the following detailed description taken in conjunction with the accompanying drawings which illustrate, by way of example, the principles of the disclosure.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates a block diagram of different components of a system that can be configured to implement the various techniques described herein, according to some embodiments.

FIG. 2 is a flow diagram depicting an embodiment of a method for managing emails.

FIG. 3 illustrates conceptual diagrams of different user interfaces that can be displayed for managing emails, according to some embodiments.

FIG. 4 is a block diagram of a system that ranks email senders for review by a user.

FIG. 5 is a block diagram of a user device for use in a system that ranks email senders.

FIG. 6 is a flow diagram depicting an embodiment of a method for ranking email senders.

FIG. 7 illustrates a detailed view of a computing device that can be used to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

The described embodiments relate generally to techniques for managing emails.

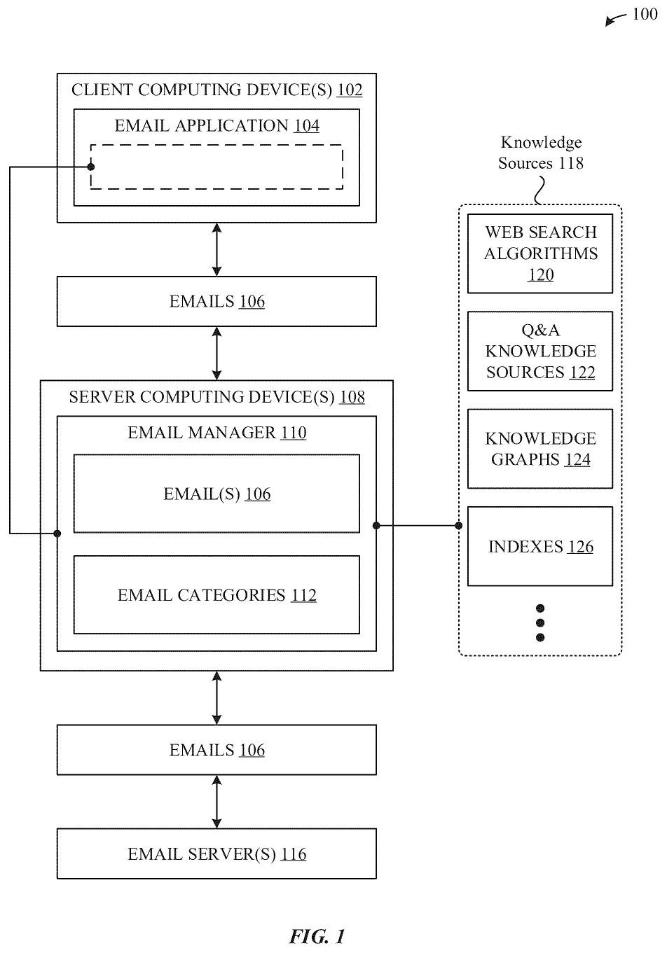

FIG. 1 illustrates a block diagram of different components of a system 100 that can be configured to implement the various techniques described herein, according to some embodiments. As shown in FIG. 1, the system 100 can include client computing device(s) 102, server computing devices 108, and email server computing devices 116. It is noted that, in the interest of simplifying this disclosure, the client computing device(s) 102, the server computing devices 108, and the email server computing devices 116 are typically discussed in singular capacities. In that regard, it should be appreciated that the system 100 can include any number of client computing device(s) 102, server computing devices 108, and email server computing devices 116, consistent with the scope of this disclosure.

According to some embodiments, client computing device(s) 102 can represent any form of computing device operated by an individual, an entity, etc., such as a wearable computing device, a smartphone computing device, a tablet computing device, a laptop computing device, a desktop computing device, a rack mount computing device, a gaming computing device, a smart home computing device, an Internet of Things (IoT) computing device, and so on. According to some embodiments, the server computing device 108 can represent any form of computing device, such as a blade server, a rack server, a tower server, and so on. It is noted that the foregoing examples are not meant to be limiting, and that client computing device(s) 102/server computing device 108 can represent any type, form, etc., of computing device, consistent with the scope of this disclosure. According to some embodiments, the email server computing device 116 can represent any computing device configured to implement a service that enables emails 106 to be transmitted between computing devices, users, etc.

As shown in FIG. 1, client computing device(s) 102 can be configured to implement an email application 104 that enables a user to interact with, transmit, receive, etc., emails 106. According to some embodiments, and as shown in FIG. 1, the email application 104 and/or the server computing device 108 can implement an email manager 110. In other words, the techniques described herein can be implemented on client computing device(s) 102 without involvement from the server computing device 108, if desired. For example, client computing device(s) 102 can interact directly with email server computing devices 116 to obtain emails, and then manage the emails on client computing device(s) 102. The techniques described herein also can be implemented, in part, on the client computing device 102 and the server computing device 108. For example, the server computing device 108 can be configured to receive emails 106 from the email server computing devices 116 on behalf of the client computing device(s) 102, and permit the client computing device(s) 102 to access the emails 106 by way of an email interface provided by the server computing device 108. It is noted that the foregoing examples are not meant to be limiting, and that the techniques described herein can be implemented in whole, or in part, across different computing devices, consistent with the scope of this disclosure.

According to some embodiments, the email manager 110 can be configured to implement one or more machine learning models. As described herein, the machine learning models can enable the email manager 110 to provide a variety of useful features, such as performing advanced searches across different modalities (e.g., an email domain, an address book domain, a calendar domain, a document management domain, etc., associated with the client computing device 102). The features can also include enabling reply emails 106 with relevant recipients, subject information, body information, attachment information, etc., to be generated in response to emails 106. The features can also include an ability to modify reply emails 106 in accordance with indicated changes, desires, etc., to be made to the reply emails 106. For example, the email manager 110 can receive a request to adjust a tone of a given reply email 106 relative to a tone that the email manager 110 originally predicted would be appropriate for the reply email 106. The request can be provided in plain language (e.g., “please make the email sound more professional”, “I'd like for it to sound a bit friendlier”, “I'd like for it to be more concise”, etc.) and interpreted by the machine learning models to effectively process the request. The features can also enable the email manager 110 to automatically categorize, sort, etc., emails 106, which can be particularly useful for sorting, filtering, deleting, etc., emails 106 that are/are not of interest. The categories—illustrated in FIG. 1 as email categories 112—can include, for example, “primary”, “transactions”, “promotions”, “updates”, etc. It is noted that the foregoing examples are not meant to be limiting, and that the email manager 110 can be configured to provide any number, type, form, etc., of email-related enhancement(s), at any level of granularity, consistent with the scope of this disclosure.

According to some embodiments, the machine learning models (also referred to herein as artificial intelligence models) can include small language models (SLMs), large language models (LLMs), rule-based models, traditional machine learning models, custom models, ensemble models, knowledge graph models, hybrid models, domain-specific models, sparse models, transfer learning models, symbolic artificial intelligence models, generative adversarial network models, reinforcement learning models, biological models, and the like. It is noted that the foregoing examples are not meant to be limiting, and that any number, type, form, etc., of AI models, can be implemented by the email manager 110—and/or other entities with which the email manager 110 collaborates—to effectively interpret emails 106, consistent with the scope of this disclosure. It is also noted that the email manager 110 can implement non-AI-based entities, such as rules-based systems, knowledge-based systems, and so on, to effectively interpret emails 106.

According to some embodiments, the email manager 110 can also implement one or more AI models to effectively generate content (such as reply emails). For example, the email manager 110 can implement generative adversarial networks (GANs), variational autoencoders (VAEs), recurrent neural networks (RNNs), convolutional neural networks (CNNs), neuroevolution systems, deep dream systems, style transfer systems, rule-based systems, interactive evolutionary algorithms, and so on. It is noted that the email manager 110 can be configured to identify and eliminate “AI hallucinations,” which refer to the generation of false or distorted perceptions, ideas, or sensations by AI systems. This phenomenon can occur when AI models, such as LLMs, generate outputs that are not based on real data but instead originate from patterns or noise present in their training data or model architecture. Such hallucinations can manifest as incorrect information, fantastical scenarios, nonsensical sentences, or a blend of real and fabricated content. It is noted that the foregoing examples are not meant to be limiting, and that any number, type, form, etc., of AI model(s), can be implemented by the email manager 110—and/or other entities with which the email manager 110 collaborates—to generate relevant/useful content, consistent with the scope of this disclosure. It is also noted that the email manager 110 can implement non-AI-based entities, such as rules-based systems, knowledge-based systems, and so on, to effectively generate relevant/useful content.

As further shown in FIG. 1, the email manager 110 can be configured to interface with knowledge sources 118 to enhance the manners in which the email manager 110 manages emails. The knowledge sources 118 can include, for example, web search engines 120, question and answer (Q&A) knowledge sources 122, knowledge graphs 124, indexes 126 (e.g., databases, approximate nearest-neighbor (ANN) indexes, inverted indexes, etc.), and so on. It is noted that the knowledge sources 118 illustrated in FIG. 1 and described herein are not meant to be limiting, and that the email manager 110 can be configured to access any type, kind, form, etc., of knowledge source 118 that is capable of receiving queries and providing responses, consistent with the scope of this disclosure. It should also be understood that the knowledge sources 118 can employ any number, type, form, etc., of AI models (or non-AI based approaches) to provide the various functionalities described herein, consistent with the scope of this disclosure. It should further be understood that the knowledge sources 118 can be implemented by any computing entity (e.g., the server computing device 108, other computing devices, etc.), service (e.g., cloud services), etc., consistent with the scope of this disclosure.

According to some embodiments, the web search engines 120 can represent web search entities that are capable of receiving queries and providing answers based on what is accessible via the Internet. To implement this functionality, the web search engines 120 can “crawl” the Internet, which involves identifying, parsing, and indexing the content of web pages, such that relevant content can be efficiently identified for search queries that are received.

According to some embodiments, the Q&A knowledge sources 122 can represent systems, databases, etc., that can formulate answers to questions that are commonly received. To implement this functionality, the Q&A knowledge sources 122 typically rely on structured or semi-structured knowledge bases that contain a wide range of information, facts, data, or textual content that is manually curated, generated from text corpora, or collected from various sources, such as books, articles, databases, or the Internet.

According to some embodiments, the knowledge graphs 124 can represent systems, databases, etc., that can be accessed to formulate answers to queries that are received. A given knowledge graph 124 typically constitutes a structured representation of knowledge that captures relationships and connections between entities, concepts, data points, etc. in a way that computing devices are capable of understanding.

According to some embodiments, the indexes 126 can represent systems, databases, etc., that can be accessed to formulate answers to queries that are received. For example, the indexes 126 can include an ANN index that constitutes a data structure that is arranged in a manner that enables similarity searches and retrievals in high-dimensional spaces to be efficiently performed. This makes the ANN indexes particularly useful when performing tasks that involve semantic information retrieval, recommendations, and finding similar data points, objects, and so on.

It is noted that the logical breakdown of the entities illustrated in FIG. 1—as well as the logical flow of the manner in which such entities communicate—should not be construed as limiting. On the contrary, any of the entities illustrated in FIG. 1 can be separated into additional entities within the system 100, combined together within the system 100, or removed from the system 100, consistent with the scope of this disclosure.

Additionally, it should be understood that the various components of the computing devices illustrated in FIG. 1 are presented at a high level in the interest of simplification. For example, although not illustrated in FIG. 1, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another.

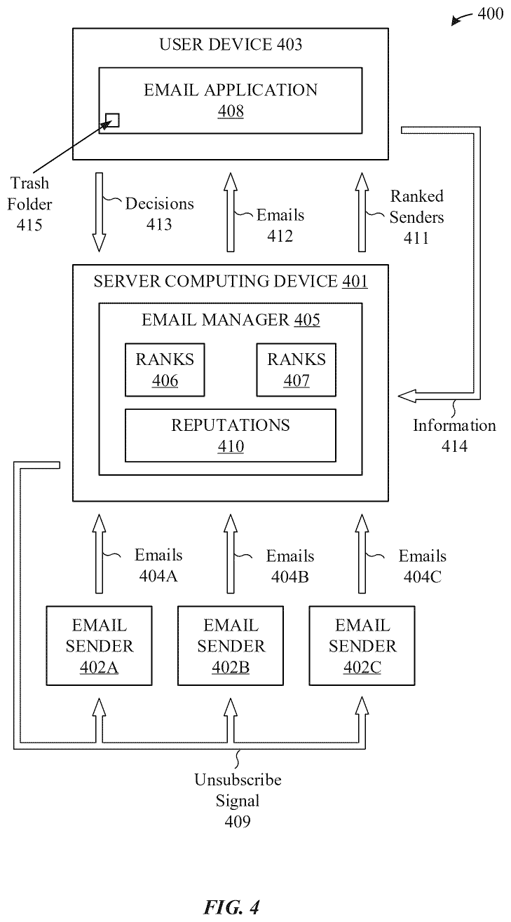

A more detailed explanation of these hardware components is provided below in conjunction with FIG. 4. It should additionally be understood that the computing devices can include other entities that enable the implementation of the various techniques described herein, consistent with the scope of this disclosure. It should additionally be understood that the entities described herein can be combined or split into additional entities, consistent with the scope of this disclosure. It should further be understood that the various entities described herein can be implemented using software-based or hardware-based approaches, consistent with the scope of this disclosure.

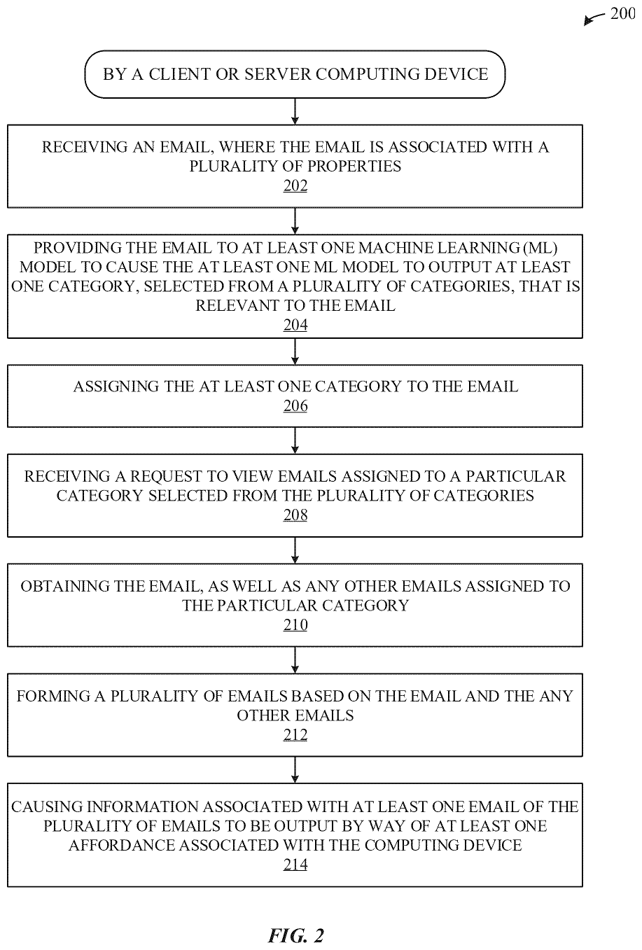

Accordingly, FIG. 1 provides an overview of the manner in which different computing devices can be configured to implement the various techniques described herein, according to some embodiments. A more detailed breakdown of the manner in which these techniques can be implemented will now be provided below in conjunction with FIGS. 2-4.

FIG. 2 illustrates a method 200 for managing emails, according to some embodiments. As shown in FIG. 2, the method 200 begins at step 202, where the computing device receives an email, wherein the email is associated with a plurality of properties. At step 204, the computing device provides the email to at least one machine learning (ml) model to cause the at least one ml model to output at least one category, selected from a plurality of categories, that is relevant to the email.

At step 206, the computing device assigns the at least one category to the email. At step 208, the computing device receives a request to view emails assigned to a particular category selected from the plurality of categories. At step 210, the computing device obtains the email, as well as any other emails assigned to the particular category.

At step 212, the computing device forms a plurality of emails based on the email and the any other emails. At step 214, the computing device causes information associated with at least one email of the plurality of emails to be output by way of at least one affordance associated with the computing device.

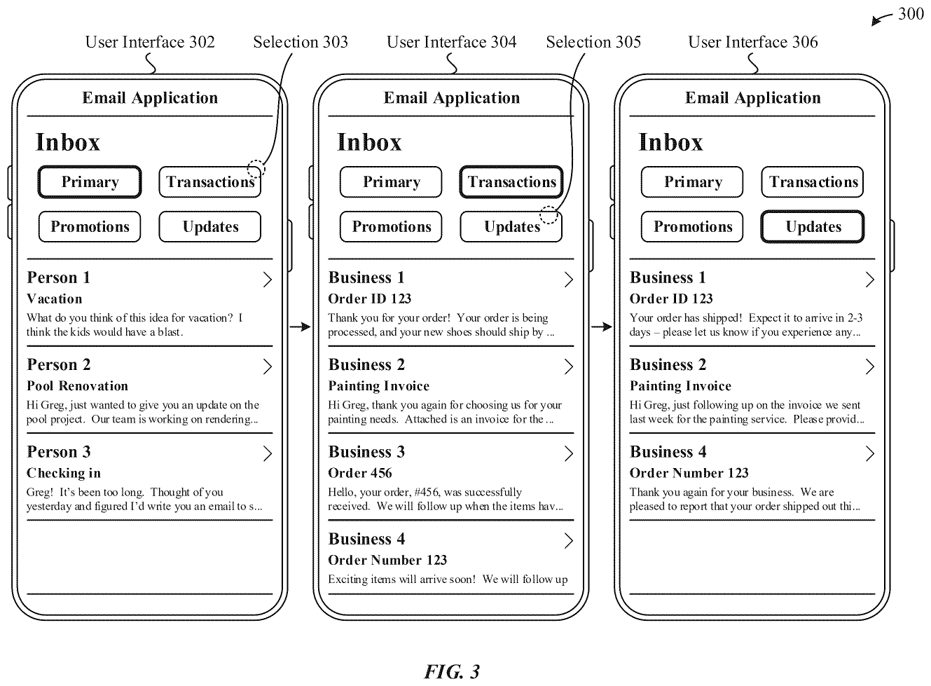

FIG. 3 illustrates conceptual diagrams 300 of different user interfaces that can be displayed for managing emails 106, according to some embodiments. In particular, the user interfaces illustrated in FIG. 3 pertain to the categorization functionalities described above in conjunction with FIGS. 1-2. As shown in FIG. 3, a user interface 302 of an email application 104 (executing on one of client computing device(s) 102) relates to an email inbox for a given email account. As shown in FIG. 3, the user interface 302 also displays four different categories (“primary”, “transactions”, “promotions”, and “updates”), where each category has been assigned to at least one email 106 associated with the email inbox. Again, these categories are merely exemplary. As shown in FIG. 3, the “primary” has been selected, and three different emails 106 are displayed in the user interface. A selection 303 is made, indicating a desire to display emails 106 associated with the “transactions” category. In turn, a user interface 304 is displayed, which includes four different emails 106 that are relevant to the “transactions” category. A selection 305 is made, indicating a desire to display emails 106 associated with the “updates” category. In turn, a user interface 306 is displayed, which includes three different emails 106 that are relevant to the “updates” category. It is noted that the user interfaces illustrated in FIG. 3 are not meant to be limiting, and that the email application 104 can employ any amount, type, form, etc., of user interface(s), user interface element(s), etc., at any level of granularity, consistent with the scope of this disclosure.

Turning to FIG. 4, a block diagram of an embodiment of a system for ranking email senders is depicted. As illustrated, system 400 includes server computing device 401, email senders 402A-402C, and user device 403. In various embodiments, user device 403 may corresponding client computing device(s) 102, and server computing device 401 may correspond to server computing device(s) 108.

Email senders 402A-402C are configured to send emails 404A-404C, respectively. In various embodiments, emails 404A-404C are routed through server computing device 401 on their way to user device 403 as emails 412. In various embodiments, email senders 402A-404C may be implemented using multiple computing device or servers. In some cases, multiple email senders of email senders 402-402C may be implemented on a common computing device or server. Although only three email senders are depicted in the embodiment of FIG. 4, in other embodiments, any suitable number of email senders may be present.

Server computing device 401 is configure to execute email manager 405 to perform multiple operations. In various embodiments, the operations may include determining a plurality of email senders for a user associated with user device 403. In some embodiments, the plurality of email senders may include any suitable number of email senders 402A-402C.

In some embodiments, the operations may include determining ranks 406 for email senders 402A-402C. In some cases, determining ranks 406 includes determining a particular rank value of ranks 406 using a number of email messages send by a corresponding email sender of email senders 402A-402C. Alternatively, or additionally, determining ranks 406 may include determining the particular rank value using a number of email messages send by the corresponding email sender of email senders 402A-402C that have not been read by the user associated with user device 403.

In some embodiments, the operations performed by server computing device 401 may further include monitoring corresponding changes in ranks 406 for email senders 402A-402C. In such cases, the operations may include determining a current value for a particular rank value based on at least one previous value for the particular rank value.

The operations performed by server computing device 401 also includes determining ranks 407 for corresponding email senders of a subset of email senders 402A-402C. In various embodiments, the operations may include determining multiple subsets of email senders 402A-402C. In different embodiments, a number of email senders included in a given subset of the multiple subsets of the plurality of email senders may be programmable.

The operations performed by server computing device 401 further include displaying, by the server computing device 401 user device 403 associated with the user, the subset of email senders 402A-402C in an order based on ranks 407. In some cases, displaying the subset of email senders 402A-402C includes sending, by server computing device 401, ranked senders 411 to user device 403. In some cases, ranked senders 411 may be displayed within email application 408 or any other suitable application or software program that can be executed by user device 403.

The operations performed by server computing device 401 also includes receiving decisions 413 regarding corresponding email senders of the subset of email senders 402A-402C. In various embodiments, decisions 413 can include information indicative of a choice from the user associated with user device 403 regarding whether or not to take action regarding a given email sender of email senders 402A-402C.

The operations performed by server computing device 401 further include performing an action associated with a particular email sender of the subset of email senders 402A-402C based on a corresponding decision included in decisions 413. In various embodiments, performing the action includes sending, by the computing device based on a reputation of the particular email sender included in reputations 410, unsubscribe signal 409 to the particular email sender. In some cases, unsubscribe signal 409 is sent in response to a determination that the reputation of the particular email sender exceeds a threshold value. In cases where the reputation of the particular email sender is less than the threshold value, server computing device 401 may take other actions instead of sending unsubscribed signal 409.

In other embodiments, performing the action may include moving, based on the reputation of the particular email sender included in reputations 410, future email messages received from the particular email sender to trash folder 415. In some cases, trash folder 415 may be associated with user device 403. In some embodiments, performing the action may include forwarding future email messages from the particular email sender to user device 403 in response to determining that the corresponding decision of decisions 413 indicates no action be taken.

In some embodiments, the operations performed by server computing device 401 may include determining, reputations 410 for corresponding email senders of the subset of email senders 402A-402C using a plurality of internet protocol addresses associated with the subset of the plurality of email senders. Alternatively, or additionally, determining the plurality of reputations may include checking an approved email sender list.

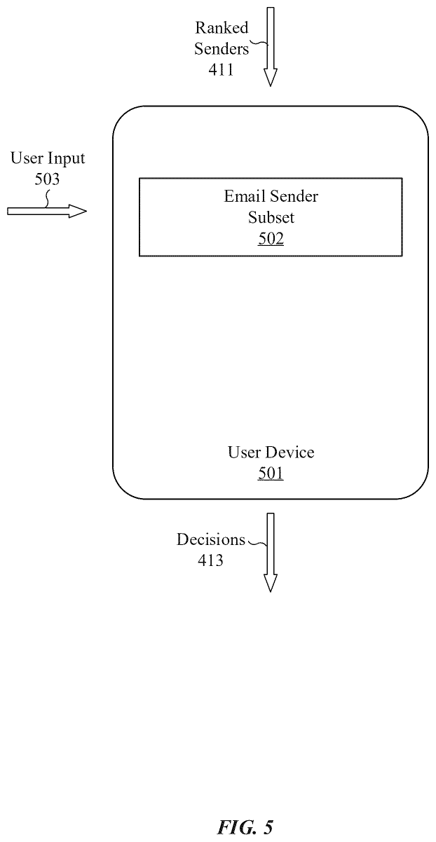

Turning to FIG. 5, a block diagram of a user device for use in a system that ranks email senders is depicted. As illustrated, user device 501 is configured to receive ranked senders 411 display email sender subset 502. In various embodiments, user device 501 may correspond to user device 403 or any of client computing device(s) 102 as depicted in FIG. 1.

As described above, email sender subset 502 may be a subset of email senders 402A-402C, and may be displayed according to corresponding rank values in ranks 407. In different embodiments, email sender subset 502 may displayed on a touchscreen or any other suitable display elements associated with user device 501.

User device 501 is further configured to receive user input 503. It is noted that user device 501 may receive user input 503 via a touchscreen, keyboard, or any other suitable input device associated with user device 501. In various embodiments, user input 503 may include information indicative of whether or not the user wants server computing device 401 to perform respective actions regarding email senders included in email sender subset 502. For example, user input 503 may include information indicative that action should be taken for email sender 402A, but that no action should be taken for email sender 402B. In different embodiments, information included in user input 503 can be translated into decisions 413, which user device 501 can send to server computing device 401.

Once user input has been received for the email senders in email sender subset 502, a new subset of email senders may be display using ranked senders 411. User device 501 may solicit additional user input 503 for the new subset of email senders to generate additional decisions of decisions 413. The process of displaying additional email sender subsets for user input until all of the email senders 402A-402C have dispositioned.

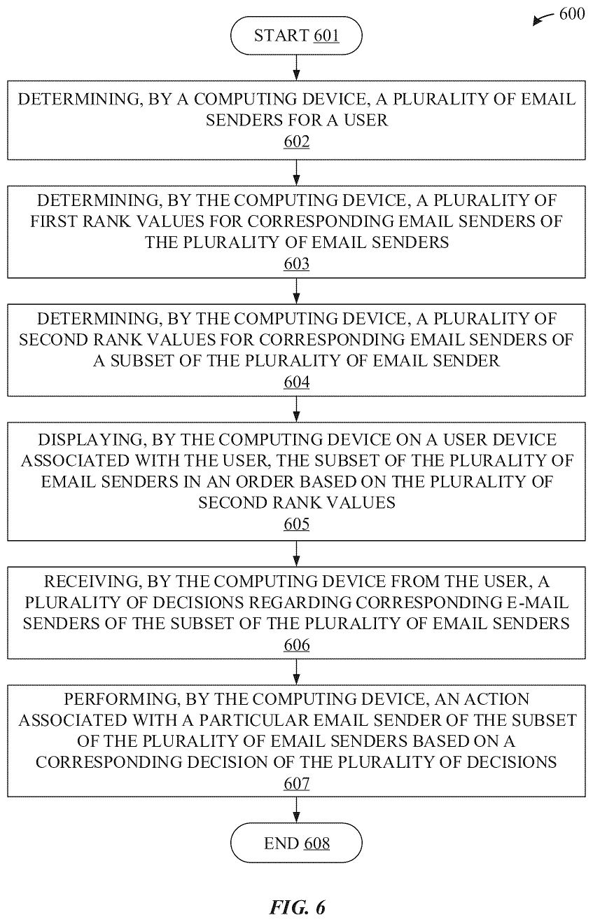

Turning to FIG. 6, a flow diagram depicting an embodiment of a method for ranking emails is illustrated. Method 600, which may be applied to various systems, e.g., system 400 as depicted in FIG. 4, begins in block 601.

Method 600 includes determining, by a computing device, a plurality of email senders for a user (block 602). In various embodiments, the plurality of email senders may correspond to email senders that are sending unwanted emails to the user. In some cases, method 600 may include determining the plurality of email senders in response to determining that a particular time period has elapsed since ranking was last performed. Alternatively, or additionally, method 600 may include determining the plurality of email senders in response to detecting a particular event. In various embodiments, the particular event may include receiving a threshold number of emails, a request from a user, or any other suitable event.

Method 600 further includes determining, by the computing device, a plurality of first rank values for corresponding email senders of the plurality of email senders (block 603). In some embodiments, determining the plurality of first rank values includes determining a particular first rank value of the plurality of first rank values using a number of email messages sent by a corresponding email sender of the plurality of email senders. Alternatively, or additionally, determining the plurality of first rank values includes determining the particular first rank value using a number of email messages sent by the corresponding email sender that have not been read by the user.

In some embodiments, method 600 may further include monitoring corresponding changes in rank values for the plurality of email senders. In such cases, method 600 may include determining, by the computing device, a current value for a particular rank value based on at least one previous value for the particular rank value.

Method 600 also includes determining, by the computing device, a plurality of second rank values for corresponding email senders of a subset of the plurality of email senders (block 604). In various embodiments, the method may include determining, by the computing device, multiple subsets of the plurality of email senders. In different embodiments, a number of email senders included in a given subset of the multiple subsets of the plurality of email senders may be programmable.

Method 600 further includes displaying, by the computing device on a user device associated with the user, the subset of the plurality of email senders in an order based on the plurality of second rank values (block 605).

Method 600 also includes receiving, by the computing device from the user, a plurality of decisions regarding corresponding email senders of the subset of the plurality of email senders (block 606).

Method 600 further includes performing, by the computing device, an action associated with a particular email sender of the subset of the plurality of email senders based on a corresponding decision of the plurality of decisions (block 607). In various embodiments, performing the action includes sending, by the computing device based on a reputation of the particular email sender, an unsubscribed signal to the particular email sender.

In other embodiments, performing the action may include moving, by the computing device based on the reputation of the particular email sender, future email messages received from the particular email sender to a trash folder. In some cases, the trash folder may be associated with the user device. In some embodiments, performing the action may include forwarding, by the computing device, future email messages from the particular email sender to the user device in response to determining that the corresponding decision indicates no action be taken.

In some embodiments, method 600 may include determining, by the computing device, a plurality of reputations for corresponding email senders of the subset of the plurality of email senders using a plurality of internet protocol addresses associated with the subset of the plurality of email senders. Alternatively, or additionally, determining the plurality of reputations may include checking an approved email sender list.

The method concludes in block 608. It is noted that, in some embodiments, method 600 may be used in combination with the method described in FIG. 2.

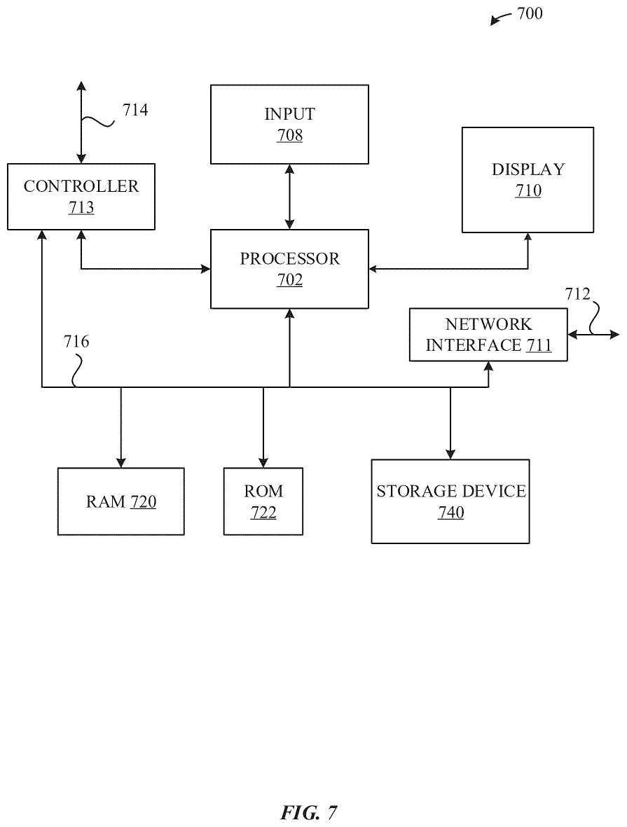

FIG. 7 illustrates a detailed view of a computing device 700 that can be used to implement the various components described herein, according to some embodiments. In particular, the detailed view illustrates various components that can be included in the computing devices described above in conjunction with FIGS. 1, 4, and 5.

As shown in FIG. 7, the computing device 700 can include a processor 702 that represents a microprocessor or controller for controlling the overall operation of computing device 700. The computing device 700 can also include a user input device 708 that allows a user of the computing device 700 to interact with the computing device 700. For example, the user input device 708 can take a variety of forms, such as a button, keypad, dial, touch screen, audio input interface, visual/image capture input interface, input in the form of sensor data, etc. Furthermore, the computing device 700 can include a display 710 (screen display) that can be controlled by the processor 702 to display information to the user. A data bus 716 can facilitate data transfer between at least a storage device 740, the processor 702, and a controller 713. The controller 713 can be used to interface with and control different equipment through an equipment control bus 714. The computing device 700 can also include a network/bus interface 711 that couples to a data link 712. In the case of a wireless connection, the network/bus interface 711 can include a wireless transceiver.

The computing device 700 also includes a storage device 740, which can comprise a single disk or a plurality of disks (e.g., SSDs), and includes a storage management module that manages one or more partitions within the storage device 740. In some embodiments, storage device 740 can include flash memory, semiconductor (solid state) memory or the like. The computing device 700 can also include a Random-Access Memory (RAM) 720 and a Read-Only Memory (ROM) 722. The ROM 722 can store programs, utilities, or processes to be executed in a non-volatile manner. The RAM 720 can provide volatile data storage, and stores instructions related to the operation of the computing devices described herein.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users.

Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

What is claimed is:

1. A method, comprising:
determining, by a computing device, a plurality of email senders for a user;
determining, by the computing device, a plurality of first rank values for corresponding email senders of the plurality of email senders;
determining, by the computing device, a plurality of second rank values for corresponding email senders of a subset of the plurality of email sender;
displaying, by the computing device on a user device associated with the user, the subset of the plurality of email senders in an order based on the plurality of second rank values;
receiving, by the computing device from the user, a plurality of decisions regarding corresponding email senders of the subset of the plurality of email senders; and
performing, by the computing device, an action associated with a particular email sender of the subset of the plurality of email senders based on a corresponding decision of the plurality of decisions.

2. The method of claim 1, wherein performing the action includes sending, by the computing device based on a reputation of the particular email sender, an unsubscribe signal to the particular email sender.

3. The method of claim 1, wherein performing the action includes moving, by the computing device based on a reputation of the particular email sender, future email message received from the particular email sender to a trash folder.

4. The method of claim 1, wherein determining the plurality of first rank values includes determining a particular first rank value of the plurality of first rank values using a number of email messages sent by a corresponding email sender of the plurality of email senders.

5. The method of claim 1, wherein determining the plurality of first rank values includes determining a particular first rand value of the plurality of first rank values using a number of email messages sent by a corresponding email sender of the plurality of email senders that have not been read by the user.

6. The method of claim 1, further comprising determining, by the computing device, a plurality of reputations for corresponding email senders of the subset of the plurality of email senders using a plurality of IP-addresses associated with the subset of the plurality of email senders.

7. A non-transitory computer-accessible storage medium having program instructions stored therein that, in response to execution by a computer system, cause the computer system to perform operations including:
determining, by a computing device, a plurality of email senders for a user;
determining, by the computing device, a plurality of first rank values for corresponding email senders of the plurality of email senders;
determining, by the computing device, a plurality of second rank values for corresponding email senders of a subset of the plurality of email sender;
displaying, by the computing device on a user device associated with the user, the subset of the plurality of email senders in an order based on the plurality of second rank values;
receiving, by the computing device from the user, a plurality of decisions regarding corresponding email senders of the subset of the plurality of email senders; and
performing, by the computing device, an action associated with a particular email sender of the subset of the plurality of email senders based on a corresponding decision of the plurality of decisions.

8. The non-transitory computer-accessible storage medium of claim 7, wherein performing the action includes sending, by the computing device based on a reputation of the particular email sender, an unsubscribe signal to the particular email sender.

9. The non-transitory computer-accessible storage medium of claim 7, wherein performing the action includes moving, by the computing device based on a reputation of the particular email sender, future email message received from the particular email sender to a trash folder.

10. The non-transitory computer-accessible storage medium of claim 9, wherein the reputation of the particular email sender is based on an IP-address associated with the particular email sender.

11. The non-transitory computer-accessible storage medium of claim 7, wherein determining the plurality of first rank values includes determining a particular first rank value of the plurality of first rank values using a number of email messages sent by a corresponding email sender of the plurality of email senders.

12. The non-transitory computer-accessible storage medium of claim 7, wherein determining the plurality of first rank values includes determining a particular first rank value of the plurality of first rank values using a number of email messages sent by a corresponding email sender of the plurality of email senders that have not been read by the user.

13. The non-transitory computer-accessible storage medium of claim 7, wherein the operations further include determining, by the computing device, a plurality of reputations for corresponding email senders of the subset of the plurality of email senders using a plurality of IP-addresses associated with the subset of the plurality of email senders.

14. A system, comprising:
one or more memory circuits configured to store instructions; and
one or more processor circuits configured to receive the instructions from the one or more memory circuits and execute the instructions to cause the system to perform operations including:
determining, by the system, a plurality of email senders for a user;
determining, by the system, a plurality of first rank values for corresponding email senders of the plurality of email senders;
determining, by the system, a plurality of second rank values for corresponding email senders of a subset of the plurality of email sender;
displaying, by the system on a user device associated with the user, the subset of the plurality of email senders in an order based on the plurality of second rank values;
receiving, by the system from the user, a plurality of decisions regarding corresponding email senders of the subset of the plurality of email senders; and
performing, by the system, an action associated with a particular email sender of the subset of the plurality of email senders based on a corresponding decision of the plurality of decisions.

15. The system of claim 14, wherein performing the action includes sending, by the system based on a reputation of the particular email sender, an unsubscribe signal to the particular email sender.

16. The system of claim 14, wherein performing the action includes moving, by the system based on a reputation of the particular email sender, future email message received from the particular email sender to a trash folder.

17. The system of claim 14, wherein determining the plurality of first rank values includes determining a particular first rank value of the plurality of first rank values using a number of email messages sent by a corresponding email sender of the plurality of email senders.

18. The system of claim 14, wherein determining the plurality of first rank values includes determining a particular first rank value of the plurality of first rank values using a number of email messages sent by a corresponding email sender of the plurality of email senders that have not been read by the user.

19. The system of claim 14, wherein determining the plurality of email senders for the user includes determining, by the system, the plurality of email senders in response to determining a particular time period has elapsed.

20. The system of claim 14, wherein the operations further include determining, by the system, a plurality of reputations for corresponding email senders of the subset of the plurality of email senders using a plurality of IP-addresses associated with the subset of the plurality of email senders.
